(19) United States
(12) Patent Application Publication
(10) Pub. No.: US 2007/0251075 A1
(43) Pub. Date: Nov. 1, 2007

(54) Thermal sealing-machine tools and method of making same

(75) Inventors: Gunter Felk, Ulm-Ensingen (DE); Wolfgang Krahl, Laupheim (DE)

Correspondence Address: K.F. ROSS P.C., 5683 RIVERDALE AVENUE, SUITE 203 BOX 900, BRONX, NY, 10471-0900, US

(73) Assignee: UHLMANN Pac-Systeme GmbH & Co. KG

(21) Appl. No.: 11/789,057

(22) Filed: Apr. 23, 2007

(30) Foreign Application Priority Data
Apr. 27, 2006 (DE) 102006020232.5-27

(51) Int. Cl. B23Q 17/00

(52) U.S. Cl. 29/407.01; 29/407.05

(57) ABSTRACT

Sealing tools for use in a thermal sealing machine each have a plurality of ridges oriented to engage together on opposite sides of a plurality of thermally bondable foils with the tools at substantially different operating temperatures when engaged with the foils during a sealing operation. These tools are made by first manufacturing one of the tools to a predetermined ridge-to-ridge spacing and then ascertaining the ridge-to-ridge spacing of the one tool at the respective operating temperature. Then a difference between a ridge-to-ridge spacing of the other of the tools is calculated at a predetermined manufacturing temperature and the respective operating temperature. Finally the other tool is manufactured at the manufacturing temperature with a ridge-to-ridge spacing equal to the ridge-to-ridge spacing at the respective operating temperature minus the calculated difference.

### FIELD OF THE INVENTION

The present invention relates to a thermal sealing machine. More particularly this invention concerns tools for such a machine and a method of making the tools.

### BACKGROUND OF THE INVENTION

In many manufacturing and/or packaging operations it is necessary to thermally bond together two or more foils according to a pattern. Typically the lower foil is formed with an array of small pockets each holding, for example, a pill or other small object, and the upper foil is planar. The lower foil is stepped between a lower tool formed with an array of cavities into which the pockets fit and the upper tool can be brought down to press the upper foil against flat upper surfaces of ridges that define these cavities. The lower tool is normally kept at relatively cool temperature Tₛ₁ so that the lower foil does not deform and that the contents of the pockets are not excessively heated, but the upper tool is at a hot enough temperature Tₛ₂ to at least partially melt the upper foil so that it bonds in a weld all around each pocket of the lower foil. The resultant laminate thus neatly and hermetically contains the objects.

Since the scale of the operation is very small, it is therefore essential that the ridge formations forming the lowermost surfaces of the upper tool align perfectly with the formations forming the uppermost surfaces of the lower tool. If the upper and lower ridges forming the seal surfaces of the tools do not align perfectly, the result can be a spoiled package or product.

In the production of such sealing tools, generally in casting or forging processes or by use of CNC machines, an identical distribution of the ridges is produced at the manufacturing temperature, thus producing exchangeable sealing tools.

In the use of such sealing tools produced according to the manufacturing method, degradation in the seal quality routinely occurs which, after intensive analysis of the process sequence and the sealing profile, has been attributed to thermally caused dimensional changes in the sealing tools during the sealing process. In the sealing process, one sealing tool is heated according to specifications, and the other sealing tool is cooled. As a result of these different operating temperatures, corresponding to their linear coefficients of thermal expansion the spacings between the ridges of sealing tools changes, which works against controlled and uniform introduction of force and heat into the workpiece and results in a degradation of the seal quality.

### OBJECTS OF THE INVENTION

It is therefore an object of the present invention to provide improved thermal heat-sealing tools.

Another object is the provision of a method of making such improved thermal heat-sealing tools that overcome the above-given disadvantages.

### SUMMARY OF THE INVENTION

A method of making sealing tools for use in a thermal sealing machine. The tools each having a plurality of ridges oriented to engage together on opposite sides of a plurality of thermally bondable foils with the tools are at substantially different operating temperatures when engaged with the foils during a sealing operation. The method has according to the invention the steps of manufacturing one of the tools to a predetermined ridge-to-ridge spacing, ascertaining the ridge-to-ridge spacing of the one tool at the respective operating temperature, calculating a difference between a ridge-to-ridge spacing of the other of the tools at a predetermined manufacturing temperature and the respective operating temperature, and manufacturing the other tool at the manufacturing temperature with a ridge-to-ridge spacing equal to the ridge-to-ridge spacing at the respective operating temperature minus the calculated difference.

In other words according to the invention starting from a ridge-to-ridge spacing A_{Ts1} of one of the tools at the respective operating temperature, a ridge-to-ridge spacing A_{Tf2} of the other tool at a manufacturing temperature is determined such that a ridge-to-ridge spacing of the other tool at the respective operating temperature A_{Ts2} corresponds the ridge-to-ridge spacing of the one tool Aₛ₁ at the respective operating temperature.

Such a manufacturing method has the advantage that during the sealing process the ridges of the two sealing tools used in a sealing machine are positioned identically on the tool surface, so that when the ridges are configured in a mirror image with respect to the plane of the foil, i.e. the ridges are positioned exactly opposite one another on the sealing tools, a precisely defined application of force and heat on the foils is ensured. As a result, the seal quality is improved over the entire weld.

Within the scope of the invention, for the manufacture of the one sealing tool it is particularly preferred that the distance A_{Tf} between the ridges of the other tool is set by use of the linear coefficients of thermal expansion α₂ for the other sealing tool and a temperature gradient ΔT₂ which results from the difference of the sealing temperature Tₛ₂ of the other tool and it's the manufacturing temperature T_{f}, according to the relationship

A_{Tf2}=A_{Ts2}/(α₂*ΔT₂+1).

In this manner, the exact distance between the ridges may be easily set as a function of the functionally corresponding sealing tool, taking into account the manufacturing temperature and the operating temperature, i.e. the sealing temperature, of the one sealing tool.

Furthermore, it is preferred that, based on the distance A_{Ts1}, set a priori, between the ridges of the one sealing tool at the sealing temperature thereof, the distance A_{Tf1} between the ridges at the manufacturing temperature is set by use of the linear coefficients of thermal expansion α₁ for the sealing tool and a temperature gradient ΔT₁ which results from the difference of the sealing temperature Tₛ₁ and the manufacturing temperature T_{f1}, according to the relationship

A_{Tf1}=A_{Ts1}/(α₁*ΔT₁+1).

This has the advantage that the shaping of the sealing tool to be manufactured is coordinated with the requirements for the sealing surface, and furthermore, for any operating temperature of the sealing tools a corresponding sealing tool can be provided.

The portion of the inventive object pertaining to the sealing machine is achieved by attaching the sealing tools to the associated tool holder at one location and/or at multiple locations in the sealing machine. These types of attachment ensure unhindered and consistent thermal expansion of the tool, thereby guaranteeing a uniform configuration of the ridges on the sealing tools, regardless of the temperature thereof, and allow use to be made of the advantages resulting from the special manufacturing of the sealing tools.

It is also within the scope of the invention for the ridges of the sealing tools to have a mirror-image configuration with respect to the plane of the foil. This allows precise introduction of force and heat at defined locations on the foils, thereby enabling a very precise sealing profile.

Furthermore, the invention provides that at least the position of one sealing tool may be finely adjusted in the plane of the associated tool holder. This fine adjustment enables the precise mirror-image configuration of the ridges of the two sealing tools when the sealing temperature is reached. This also allows the ridges to be readjusted, so that this configuration is also guaranteed during operation.

### BRIEF DESCRIPTION OF THE DRAWING

The above and other objects, features, and advantages will become more readily apparent from the following description, reference being made to the accompanying drawing in which:

FIG. 1 is a schematic cross section through the ideal sealing tools during a sealing process;

FIG. 2 is a schematic cross section through the sealing tools manufactured according to the invention, at the manufacturing temperature;

FIG. 3 is a view like FIG. 2 but showing the tools at the respective sealing temperatures; and

FIG. 4 is a view like FIG. 1 of the tools shifted into a staggered position.

### SPECIFIC DESCRIPTION

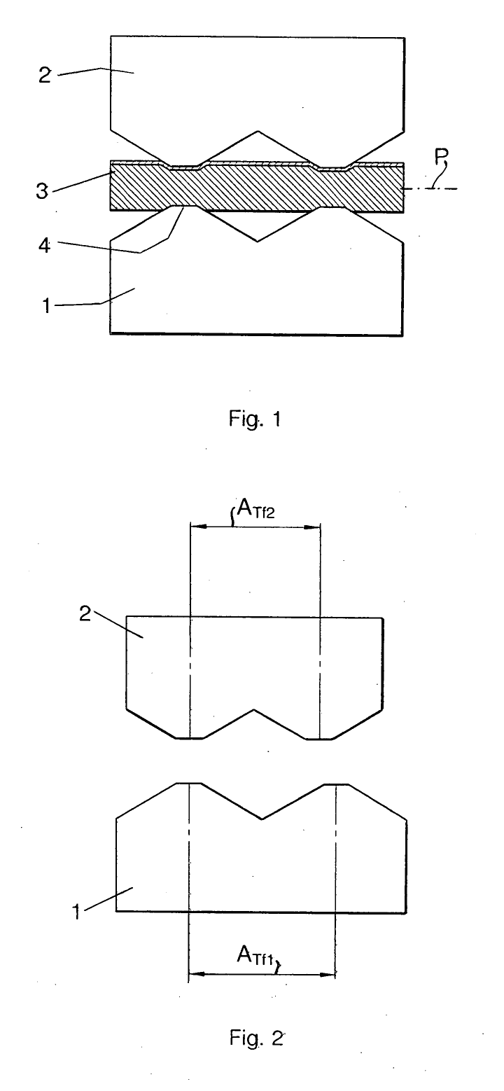

As seen in FIG. 1 a pair of generally identical sealing tools 1 and 2 for use in a sealing machine, in particular in a thermoforming machine, in which a stack of foils 3 is guided between the sealing tools 1 and 2. The one sealing tool 1 has a sealing or operating temperature Tₛ₁ during the sealing process, and the other sealing tool 2 has a sealing or operating temperature Tₛ₂. In practice for carrying out the sealing process it is routine for the temperature of one sealing tool to be markedly increased by actively heating it, and the temperature of the other sealing tool to be decreased by actively cooling it. Ridges 4 are provided on the two sealing tools, on the sides facing the stack 3 of foils, that is the lower side of the upper tool 2 and the upper side of the lower tool 1. As shown in particular in FIG. 2, the ridges of the one sealing tool 1 are spaced at a distance A_{Tf1} at the manufacturing temperature, and the ridges of the other sealing tool 2 are spaced at a distance A_{Tf2}. For the sake of simplicity, the sealing tools 1 and 2 are represented as being manufactured at the same temperature T_{f1} and T_{f2}, typically ambient temperature. For manufacture at significantly different temperatures, the distance between the ridges would have to be taken into account. Ridge-to-ridge spacings A_{Tf1} and A_{Tf2} of the tools 1 and 2 at the manufacturing spacer are therefore different according to the invention, the latter being smaller than the former because it is heated more when used.

As shown in FIG. 1, the ridges 4 are at least partially pressed into the foils 3 during the sealing process. The sum of the submerged depths of the one sealing tool 1 and of the other sealing tool 2 corresponds to the tolerance compensation. The more deeply the ridges 4 press into the foils 3, the greater the possible variation of the evenness of the sealing tools 1 and 2 and the thickness of the foils 3. Based on the spacing A_{Ts1} between the ridges of the one sealing tool 1 at the sealing temperature thereof, the distance A_{Tf2} between the ridges of the other sealing tool 2 at the manufacturing temperature thereof are set such that the distance A_{Ts2} at the sealing temperature thereof corresponds to the distance A_{Ts1} between the ridges 4 of the one sealing tool 1.

According to the invention, for the manufacture of the other sealing tool 2 the distance A_{Tf2} between the ridges 4 is set by use of the linear coefficients of thermal expansion α₂ for the sealing tool 2 and a temperature gradient ΔT₂ that is the difference between the sealing temperature Tₛ₂ of the tool 2 and its manufacturing temperature T_{f2}, according to the relationship

A_{Tf2}=A_{Ts2}/(α₂*ΔT₂+1).

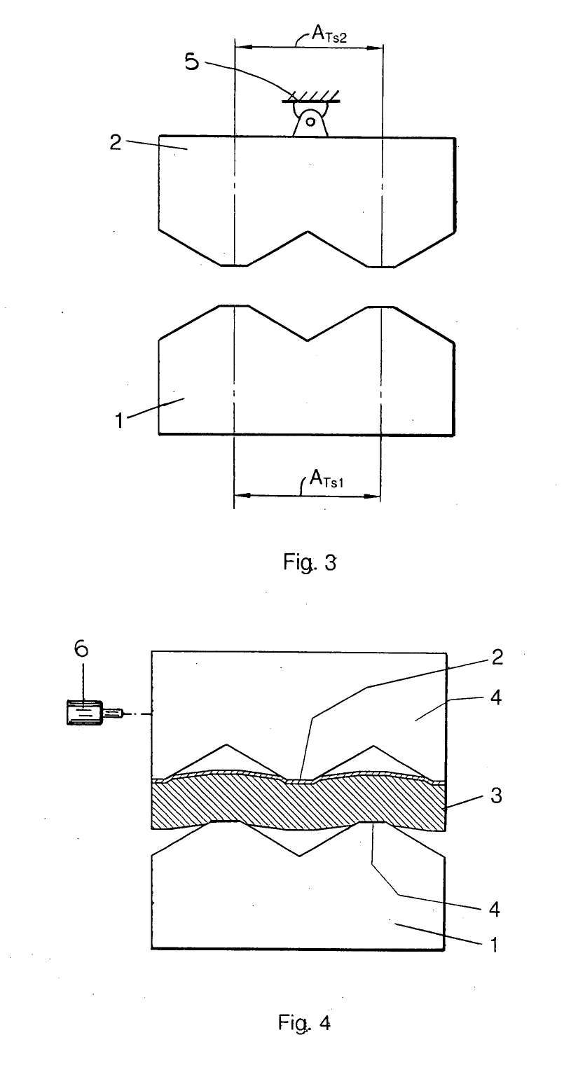

FIGS. 2 and 3 show that, due to thermal expansion, the distance between the ridges of the sealing tool 2 increases during the transition from the cold state to the higher sealing temperature for the illustrated embodiment, so that during the sealing process the distance between the ridges 4 of the sealing tool 2 manufactured according to the invention is identical to the distance between the ridges 4 of the corresponding sealing tool 1, or A_{Ts1}=A_{Ts2}.

In this method, it is not absolutely necessary to physically measure the distance between the ridges 4 of the one sealing tool 1 at the sealing temperatures; instead, according to the invention the distance A_{Ts1} between the ridges 4 of the one sealing tool 1 may be set a priori, and based upon this distance, the distance A_{Tf2} between the ridges 4 at the manufacturing temperature may be set by reusing the linear coefficients of thermal expansion α₁ for the sealing tool 1 and the temperature gradient ΔT₁ that results from the difference of the sealing temperature Tₛ₁ and the manufacturing temperature TF, according to the relationship

A_{Tf1}=A_{Ts1}/(α₁*ΔT₁+1).

In this manner it is particularly simple to manufacture sealing tools 1 and 2 for the respective sealing temperatures Tₛ₁ and Tₛ₂ while making the distances between ridges equal when the tools 1 and 2 are in use.

With regard to heat expansion, in order to obtain a uniform distance between the ridges 4 it is necessary to fasten the sealing tools 1 and 2 to the associated tool holder (not illustrated in greater detail in the drawing) in the sealing machine such that unhindered, uniform expansion is allowed in all directions with respect to shrinkage of the material. This requirement is met by a one-point attachment such as indicated schematically at 5 in FIG. 3 and/or guiding to multiple points according to the invention.

Furthermore, for a homogeneous sealing profile it is essential that the ridges 4 of the two sealing tools 1 and 2 have a mirror-image configuration with respect to a plane P of the foil. Thus, the ridges 4 of the two sealing tools 1 and 2 are situated in the same position with respect to one another at each location on the foil stack 3, resulting in a spatially defined introduction of force and heat at comparable locations on the foils 3. This is indispensable for optimal seal quality, which is necessary in particular for the sealing of blister packaging and other packaging for pharmaceutical products. The geometry of the ridges may have a design that is pyramidal, conical with truncated end faces, spherical, or the like.

As shown in FIG. 4, the manufacture of sealing tools 1 and 2 according to the invention, which during the sealing process have a rippled surface pattern with identical distances between the ridges 4, is not sufficient for the mirror-image configuration of the ridges 4 with respect to the plane of the foil. According to the invention, an actuator 6 is provided that allows at least the position of one sealing tool 1 and 2 to be finely adjusted in the plane of the associated tool holder. This adjustment may be made by use of set screws, by piezoelectric or hydraulic means, or by use of a comparable apparatus.

We claim:

1. A method of making sealing tools for use in a thermal sealing machine, the tools each having a plurality of ridges oriented to engage together on opposite sides of a plurality of thermally bondable foils with the tools being at substantially different operating temperatures when engaged with the foils during a sealing operation, the method comprising the steps of:
manufacturing one of the tools to a predetermined ridge-to-ridge spacing;
ascertaining the ridge-to-ridge spacing of the one tool at the respective operating temperature;
calculating a difference between a ridge-to-ridge spacing of the other of the tools at a predetermined manufacturing temperature and the respective operating temperature; and
manufacturing the other tool at the manufacturing temperature with a ridge-to-ridge spacing equal to the ridge-to-ridge spacing at the respective operating temperature minus the calculated difference.

2. The method defined in claim 1 wherein the ridge-to-ridge spacing A_{Tf2} of the other tool at the manufacturing temperature is calculated based on the formula:
A_{Tf2}=Aₜₛ₂/(α₂*ΔT₂+1).
where
α₂=the thermal expansion coefficient of the material of the other tool;
A_{Ts2}=ridge-to-ridge spacing of other tool at the respective operating temperature; and
ΔT₂=difference between the manufacturing temperature and the operating temperature of the other tool.

3. The method defined in claim 1 wherein a ridge-to-ridge spacing Aₜₛ₁ of the one tool at the respective operating temperature is predetermined, a ridge-to-ridge spacing A_{tf1} of the one tool at the manufacturing temperature is calculated based on the formula:
A_{Tf1}=A_{Ts1}/(α₁*ΔT₁+1)
where
α₁=the thermal expansion coefficient of the material of the one tool;
A_{Ts1}=ridge-to-ridge spacing of one tool at the respective operating temperature; and
ΔT₁=difference between the manufacturing temperature and the operating temperature of the one tool.

4. A pair of thermal sealing tools made according to the method of claim 1.

5. The tools defined in claim 4 wherein the ridges of the one tool are mirror symmetrical to the ridges of the other tool.

6. The tools defined in claim 4, further comprising means for shifting the tools relative to each other parallel to a symmetry plane between the tools.
